(19) United States
(12) Patent Application Publication
(10) Pub. No.: US 2009/0236454 A1
(43) Pub. Date: Sep. 24, 2009

(54) KITCHEN UTENSIL

(76) Inventor: Tobi SCHMIDT, Westwood, NJ (US)

Correspondence Address: KEUSEY, TUTUNJIAN & BITETTO, P.C., 20 CROSSWAYS PARK NORTH, SUITE 210, WOODBURY, NY, 11797, US

(21) Appl. No.: 12/051,251

(22) Filed: Mar. 19, 2008

(51) Int. Cl. A47J 43/00

(52) U.S. Cl. 241/169.2

(57) ABSTRACT

A kitchen utensil having a first operable position and a second storage position is provided. The utensil has a head that is rotatably connected to opposing support arms and is lockable in either an operable or storage position.

### BACKGROUND

1. Technical Field

The present principles relate to kitchen utensils. More particularly, they relate to a kitchen utensil having a collapsible head or end portion.

2. Description of Related Art

The concept of collapsible or folding utensils has been shown in U.S. Pat. Nos. 4,615,120, 5,940,974, 4,589,204 and 1,768,425. In addition, U.S. published applications 2003/0234547, 2003/0029044 and 2007/0084064 disclose other collapsible and/or folding utensil configurations.

When using utensils that have large heads or ends, often times the storage of that utensil in a kitchen drawer or the like becomes troublesome, and in some cases, simply not possible. Examples of these types of kitchen utensils are potato mashers, ladles and even strainers.

### SUMMARY

It is therefore an aspect of the present principles to provide a kitchen utensil that has a collapsible head which enables the utensil to be easily stored in a drawer or the like.

According to one aspect, the kitchen utensil includes a handle having support arms being outwardly biased from each other, a utensil head rotatably connected to distal ends of each of the support arms, and means for securing the rotatable utensil head in a first operable position and a second storage position.

According to one implementation, the securing means can be made up of a geometric shaped hole at a distal end of the support arms, and connection pins connected to the utensil head and passing through the geometric shaped holes in the respective support arm. The connection pins have a cylindrical portion connected to the utensil head and a geometric shaped portion corresponding to the geometric shaped holes in the support arms.

According to another implementation, the securing means can be made up of an indexing mechanism

In a further implementation, the kitchen utensil includes a handle, a utensil head connected to the handle and having a first operable position and a second storage position, and means for rotating the utensil head into and out of the first and second positions.

Other aspects and features of the present principles will become apparent from the following detailed description considered in conjunction with the accompanying drawings. It is to be understood, however, that the drawings are designed solely for purposes of illustration and not as a definition of the limits of the present principles, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings wherein like reference numerals denote similar components throughout the views:

FIG. 1 is perspective view of a kitchen utensil according to an implementation of the present principles;

FIG. 2a is a side view of the kitchen utensil in the operable position, according to an implementation of the present principles;

FIG. 2b is a side view of the kitchen utensil while being changed from the collapsed position to the operable position;

FIG. 2c is a side view of the kitchen utensil in a collapsed storage position, according to an implementation of the present principles; and

FIGS. 3a-3d show the collapsing operation of the kitchen utensil according to an implementation of the present principles.

### DETAILED DESCRIPTION

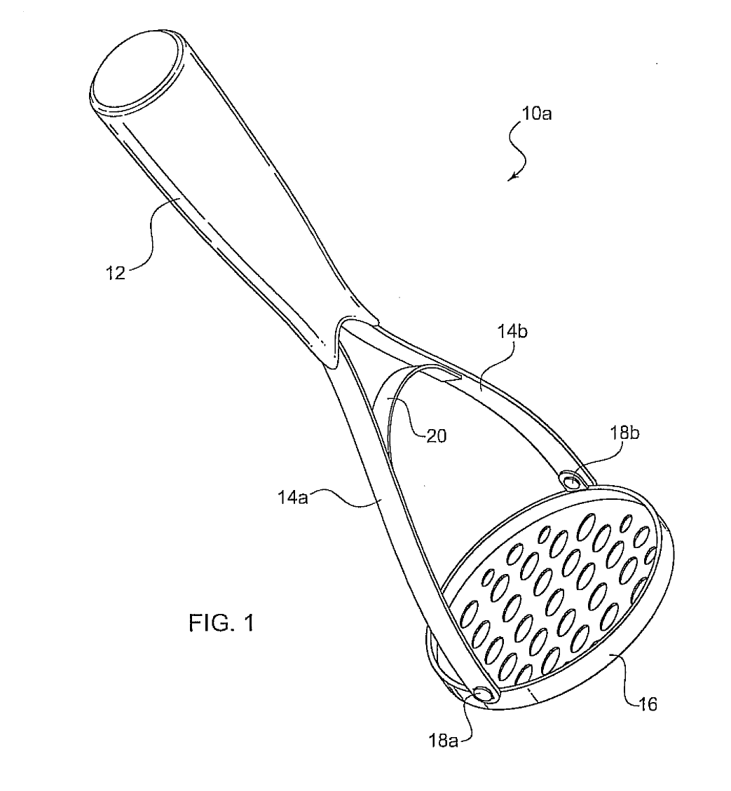

Referring to FIG. 1, the kitchen utensil 10 is shown in its operable position 10A. The utensil 10 includes a handle 12 and legs or supports 14a and 14b. The supports 14a and 14b are spring biased outwardly or away from each other by the central support 20 or other biasing device such as, for example one or more springs. The head or utensil portion 16 is connected to the ends of the supports 14a and 14b. In the example shown, utensil 10 is potato masher having a mashing head 16.

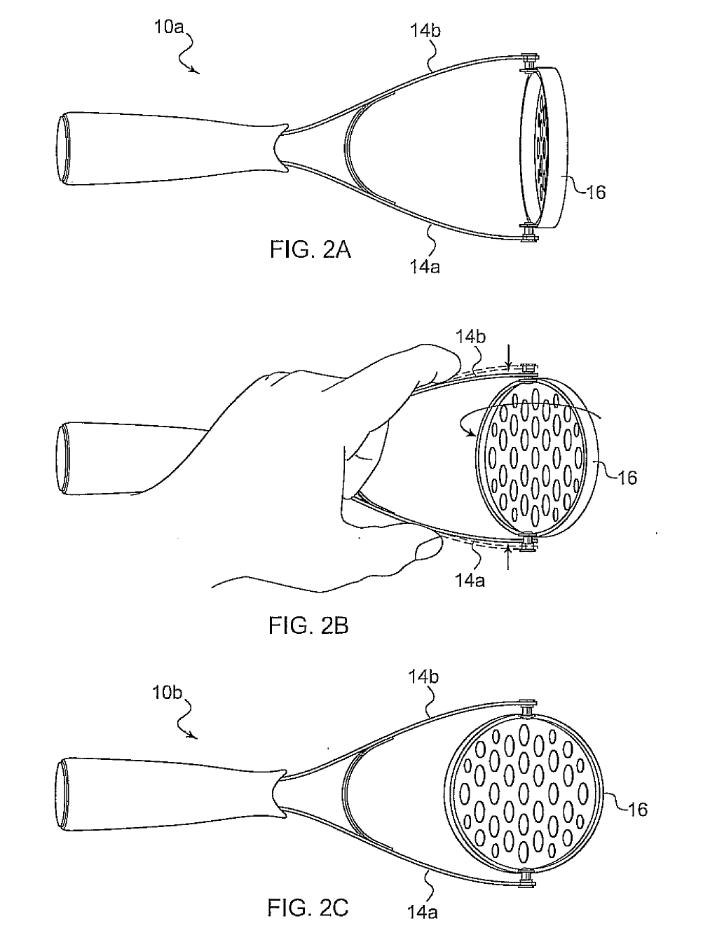

In the present example, it will be apparent to those of ordinary skill (and even the average homeowner) that the potato masher head 16, when in its operable position (See FIGS. 1, 2A), does not fit well into a drawer where other kitchen utensils are typically stored. The operable position is such that mashing head 16 extends transversely from the support arms 14 and thereby provides an increased surface area for engaging the potatoes being mashed.

It is an aspect of the present principles to provide a kitchen utensil that has a head that is rotatable so that it can be positioned in an operable and/or storage position depending on the current need. As will be shown herein, one example of a rotating system has been disclosed where the head of the kitchen utensil can be rotated in 90 degree increments. However, it is to be understood that other increments can be implemented without departing from the scope of this disclosure.

FIG. 2C shows the utensil 10 in its storage position 10b where the mashing head 16 has been rotated 90 degrees such that the head is longitudinally aligned with the support arms 14a and 14b and does not extend outwardly therefrom. In this position, the utensil 10 is easily stored in a drawer without interfering with the operation of the same.

FIG. 2B shows an example of the present principles where the supports 14a and 14b are flexed inward by the user (against the outward spring bias caused by central support 20) such that the head 16 is unlocked and becomes rotatable and capable of being positioned in a configuration different from the operable position.

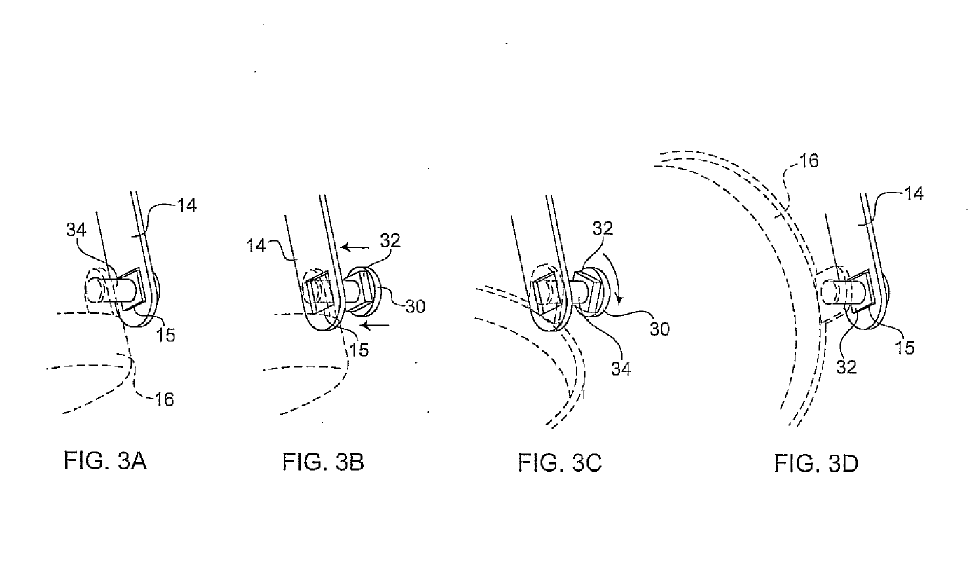

FIGS. 3A-3D show one implementation of the rotating head according to the present principles. The head 16 as fixedly secured to ends of pins 30, and the pins include a cylindrical portion 34 and a square portion 32. The support arms 14 include a square shaped aperture 15 configured to receive the square shaped portion 32 of the pin 30.

FIG. 3A shows the head 16 locked in its operable position with the square portion 32 seated within the square opening 15. Referring to FIG. 3B, when the support arm 14 is flexed inward against the outward spring bias of central support 20, the square hole 15 is disengaged from the square portion 32 of pin 30 thereby allowing head 16 to be rotated. As shown in FIG. 3C, once the square portion 32 is disengaged from the square hole 15, head 16 is rotated, and when it is in the desired flat or collapsed position, the support arm 14 is released and the square hole 15 engages the square portion 32 of the pin 30, thereby locking head 16 in the collapsed position. FIG. 3D shows the head 16 locked in the collapsed position.

According to other implementations of the present principles, other geometric shapes can be used for hole 15 and pin portion 32, such as triangle, square, pentagon, hexagon, octagon, etc. The selection of the geometric shape can be based on the desired operation and/or the desired storage capabilities of the kitchen utensil.

In yet further implementations, the rotating mechanism can be an indexed and locking system that does not require the flexing of the support arms and/or the use of the geometric shapes of the pins and support arm receiving holes. An example of such an indexing system can be seen in U.S. Pat. No. 4,771,646, which is incorporated herein by reference.

While there have been shown, described and pointed out fundamental novel features of the present principles, it will be understood that various omissions, substitutions and changes in the form and details of the methods described and devices illustrated, and in their operation, may be made by those skilled in the art without departing from the spirit of the same. For example, it is expressly intended that all combinations of those elements and/or method steps which perform substantially the same function in substantially the same way to achieve the same results are within the scope of the present principles. Moreover, it should be recognized that structures and/or elements and/or method steps shown and/or described in connection with any disclosed form or implementation of the present principles may be incorporated in any other disclosed, described or suggested form or implementation as a general matter of design choice. It is the intention, therefore, to be limited only as indicated by the scope of the claims appended hereto.

What is claimed is:

1. A kitchen utensil comprising:
a handle having support arms being outwardly biased from each other;
a utensil head rotatably connected to distal ends of each of the support arms;
means for securing the rotatable utensil head in a first operable position and a second storage position.

2. The kitchen utensil according to claim 1, wherein said securing means comprises:
a geometric shaped hole at a distal end of the support arms; and
connection pins connected to the utensil head and passing through the geometric shaped holes in the respective support arm, said connection pins having a cylindrical portion connected to the utensil head and a geometric shaped portion corresponding to the geometric shaped holes in the support arms.

3. The kitchen utensil according to claim 2, wherein the outward bias of the support arms causes the geometric shaped portion of the connection pins to engage the geometric shaped holes in the support arms such that the utensil head is secured in one of the first and second positions; and
wherein an inward force on the support arms causes the pins to disengage from the geometric shaped holes and causes the cylindrical portions of the pins to be disposed within the geometric shaped holes thereby enabling the utensil head to rotate.

4. The kitchen utensil according to claim 1, wherein the geometric shape comprises a square.

5. The kitchen utensil according to claim 1, wherein the utensil head comprises a potato masher.

6. The kitchen utensil according to claim 1, wherein the securing means comprises an indexing mechanism

7. A kitchen utensil comprising:
a handle;
a utensil head connected to the handle and having a first operable position and a second storage position; and
means for rotating the utensil head into and out of the first and second positions.

8. The kitchen utensil according to claim 7, further comprising:
a first support arm connected at one end to the handle and the utensil head at the other end;
a second support arm connected at one end to the handle and the utensil head at the other end;
a central support positioned between the first and second support arms and configured to bias the first and second support arms in an outward direction.

9. The kitchen utensil according to claim 7, further comprising means for locking the utensil head in one of the first or second positions.

10. The kitchen utensil according to claim 9, wherein said locking means comprises:
a geometric shaped hole at the other end of each of said first and second support arms; and
connection pins connected to the utensil head and passing through the geometric shaped holes in the respective support arm, said connection pins having a cylindrical portion connected to the utensil head and a geometric shaped portion corresponding to the geometric shaped holes in the support arms;
wherein the outward spring bias of the support arms causes the geometric shaped portion of the connection pins to fit within the geometric shaped holes in the support arms such that rotation of the utensil head is locked.

11. The kitchen utensil according to claim 10, wherein said rotating means comprises the cylindrical portions of the connection pins, wherein flexing the support arms inward toward each other causes the geometric shaped holes to disengage from the geometric shaped portion of the connection pins such that the cylindrical pin portion rotates freely within the geometric shaped hole of the support arms.

12. The kitchen utensil according to claim 10, wherein the geometric shaped hole comprises a square.

13. The kitchen utensil according to claim 7, wherein the utensil head comprises a potato mashing head.

14. The kitchen utensil according to claim 7, wherein the rotating means comprises an indexing mechanism.
